(19) United States
(12) Patent Application Publication
(10) Pub. No.: US 2024/0429472 A1
(43) Pub. Date: Dec. 26, 2024

(54) TEMPERATURE SENSING APPARATUS

(71) Applicant: Rivian IP Holdings, LLC, Irvine, CA (US)

(72) Inventor: Pierluigi Leccese, Irvine, CA (US)

(21) Appl. No.: 18/341,061

(22) Filed: Jun. 26, 2023

(51) Int. Cl. H01M 10/42; H01M 10/637; H01R 13/187; H01R 13/436; H01R 13/627

(52) U.S. Cl. CPC H01M 10/4285; H01M 10/637; H01R 13/187; H01R 13/4368; H01R 13/6272; H01M 2220/20

(57) ABSTRACT

An apparatus can include a sensing element disposed at least partially in a housing. The sensing element can be held in the housing via a locking component and a member. The locking component and the member can cause the sensing element to remain in contact with a battery cell of a vehicle.

### INTRODUCTION

Devices can be used to detect a temperature of a component of a vehicle.

### SUMMARY

At least one aspect is directed to an apparatus. The apparatus can include a sensing element disposed at least partially in a housing. The sensing element can be held in the housing via a locking component and a member. The locking component and the member can cause the sensing element to remain in contact with a battery cell of a vehicle.

At least one aspect is directed to a method. The method can include providing a housing. The method can include disposing a portion of a sensing element within the housing. The method can include coupling a locking component with the housing. The method can include disposing a member between the sensing element and the locking component. The locking component and the member can cause the sensing element to remain in contact with a battery cell.

At least one aspect is directed to a vehicle. The vehicle can include a battery subassembly (e.g., a battery module). The battery subassembly can comprise one or more battery cells. The vehicle can include a housing assembly coupled with the battery subassembly. The housing assembly can include a housing. The housing assembly can include a sensing element disposed at least partially in the housing. The housing assembly can include a locking component to hold the sensing element within the housing. The housing assembly can include a member disposed between the sensing element and the locking component to cause the sensing element to remain in contact with a battery cell of a vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a perspective view of an example housing assembly, in accordance with some aspects.

FIG. 2 depicts an exploded view of an example housing assembly, in accordance with some aspects.

FIG. 3 depicts a perspective view of an example sensing element, in accordance with some aspects.

FIG. 4 depicts a perspective view of an example housing, in accordance with some aspects.

FIG. 5 depicts a cross-sectional view of an example housing assembly, in accordance with some aspects.

FIG. 6 depicts a rear view of an example housing, in accordance with some aspects.

FIG. 7 depicts a perspective view of an example locking component, in accordance with some aspects.

FIG. 8 depicts side views of example housing assemblies, in accordance with some aspects.

FIG. 9 depicts top views of example housing assemblies, in accordance with some aspects.

FIG. 10 depicts a cross-sectional view of a portion of an example battery subassembly, in accordance with some aspects.

FIG. 11 depicts an electric vehicle, in accordance with some aspects.

FIG. 12 depicts an example battery pack, in accordance with some aspects.

FIG. 13 depicts a flow diagram illustrating an example method of assembling a housing assembly, in accordance with some aspects.

FIG. 14 depicts cross-sectional view of an example battery subassembly 1000, in accordance with some aspects.

### DETAILED DESCRIPTION

Following below are more detailed descriptions of various concepts related to, and implementations of, methods, apparatuses, and systems of sensing or detecting temperatures of a battery cell. The various concepts introduced above and discussed in greater detail below may be implemented in any of numerous ways.

This technical solution is directed to systems and methods of sensing a temperature of a target object. For example, this technical solution can include a housing assembly that can facilitate installation of a sensing element (e.g., a battery cell thermistor) to provide accurate and robust temperature sensing of a battery pack, which can improve the functioning of a battery pack. The technology can use a spring-loaded mechanism to desensitize material variation and can include a locking component to promote proper installation and retention of the sensing element. The disclosed solution can facilitate quick connection and release of the sensing element without needing tools for installation or removal. The housing assembly can position and secure the sensing element appropriately without the use of additional fasteners. The disclosed solution can reduce the number of elements used to secure the sensing element in place, and can facilitate proper placement of the thermistor to provide improved and more consistent temperature sensing of a battery cell of a battery pack.

The disclosed solutions can include a housing assembly. The housing assembly can include a housing, a sensing element, a locking component, and a complaint member. The housing can provide a structure to support and position the sensing element such that the sensing element can maintain constant contact with at target object (e.g., battery cell). The compliant member can provide tolerance to the sensing element such that the sensing element can maintain the contact despite material or spacing variations. The locking component can lock the sensing element in place within the housing. The locking component can be removably coupled with the housing. The housing assembly can include an engagement prevent feature to prevent premature locking of the locking component with the housing. For example, the housing can be coupled with, or partially disposed in, an external element (e.g., a battery subassembly, a battery module). The housing assembly can prevent the locking component from fully locking with the housing until the housing is coupled with or disposed in the battery subassembly. The housing assembly can facilitate easy engagement and disengagement between the housing and the locking component such that parts can be replaced easily and installation of the housing assembly can be done without additional components or fasteners.

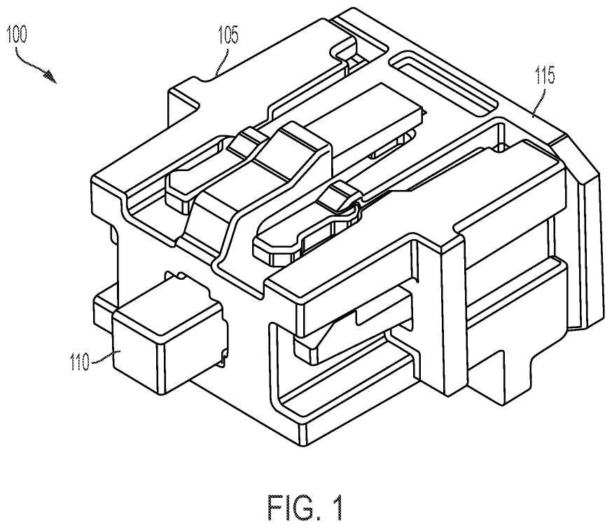

FIG. 1 depicts an example apparatus, shown as housing assembly 100. The housing assembly 100 can be a temperature sensing apparatus. The housing assembly 100 can provide structural support for a sensing element (e.g., a thermistor) to cause the sensing element maintain contact with a target object (e.g., a battery cell) or to maintain a desired position. Proper placement of the sensing element can improve accuracy and consistency of readings or detections made by the sensing element. The housing assembly 100 can include at least one housing 105. The housing 105 can be made of any material capable of retaining the structure of the housing 105. The material can be an insulating material to prevent or reduce current or voltage transfer via the housing 105. For example, the housing 105 can be a plastic that is non-conductive and resistant to temperatures that may occur around the target object.

The housing 105 can couple with an external component (e.g., a battery subassembly, a battery module) to provide a support structure to position a device or element at a desired position or location relative to the external component. The housing assembly 100 can include at least one sensing element 110. The sensing element 110 can be disposed at least partially in the housing 105. The sensing element 110 can be any element capable of reading, measuring, or detecting various properties, characteristics, or signals. For example, the sensing element 110 can detect a temperature. The sensing element 110 can, for example, be a thermistor (e.g., a resistance thermometer wherein the resistance can depend on a temperature).

The housing assembly 100 can include at least one locking component 115. The locking component 115 can hold the sensing element 110 within the housing 105. For example, the locking component 115 can dispose or orient the sensing element 110 in a specific position within the housing 105. The locking component 115 can be coupled with the housing 105. For example, the locking component 115 can be removably coupled with the housing 105.

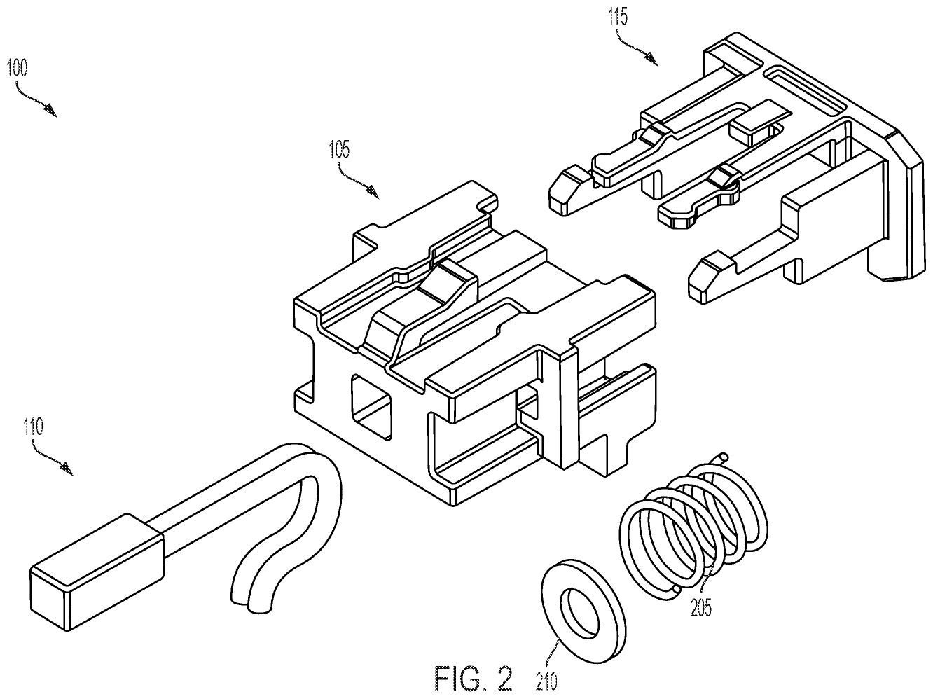

FIG. 2 depicts an exploded view of the housing assembly 100. The housing assembly 100 can include at least one member 205. The member 205 can be disposed between the sensing element 110 and the locking component 115. The member 205 can cause the sensing element 110 to remain in contact with a target object (e.g., a battery cell). The member 205 can be a compliant member 205. For example, the member 205 can be flexible or compliant to accommodate for various tolerances regarding the housing assembly 100 and the target objects. The member 205 can provide tolerance to the sensing element 110 to keep the sensing element 110 in contact with the target object (e.g., battery cell). For example, the member 205 can be compressible or extendable. The member 205 can be a spring.

The housing assembly 100 can include at least one contact member, shown as washer 210. The washer 210 can be disposed between at least a portion of the sensing element 110 and member 205. The member 205 can be disposed between the washer 210 and the locking component 115. The member 205 can extend between the washer 210 and the locking component 115. The washer 210 can provide a surface for the member 205 apply a force to be exerted on a portion of the sensing element 110 to keep the sensing element 110 in contact with the target object.

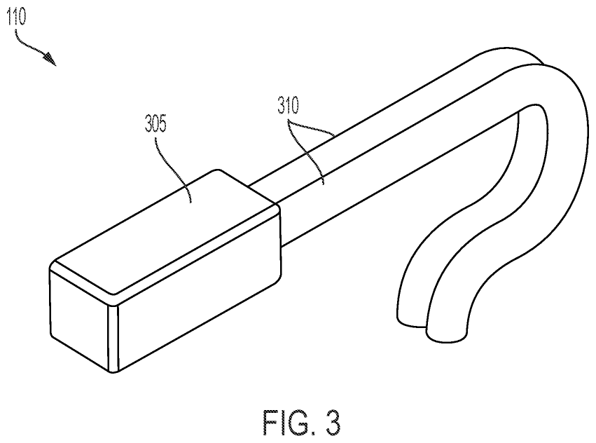

FIG. 3 depicts a perspective view of the sensing element 110. The sensing element 110 can include at least one head 305. The head 305 can contact a target object (e.g., a battery cell). The head 305 can be, for example, a box. For example, the head 305 can be a rectangular box. The sensing element 110 can include at least one conduit 310. The conduit 310 can be any element that can facilitate detection of a property or transfer of a signal. For example, the conduit 310 can be a wire or a plurality of wires. The conduit 310 can be coupled with the head 305. For example, a portion of the conduit 310 can be disposed in the head 305. A portion of the conduit 310 can be disposed external to the head 305. For example, a portion of the conduit 310 can extend from the head 305 and be disposed outside the head 305. The conduit 310 can couple with a receiving component (e.g., a computing device). The receiving component can receive the signal or other data that is measured, read, or detected by the sensing element 110 and transmitted or carried by the conduit 310. The washer 210 can be disposed between the head 305 and the member 205. The washer 210 and the member 205 can be disposed around the conduit 310.

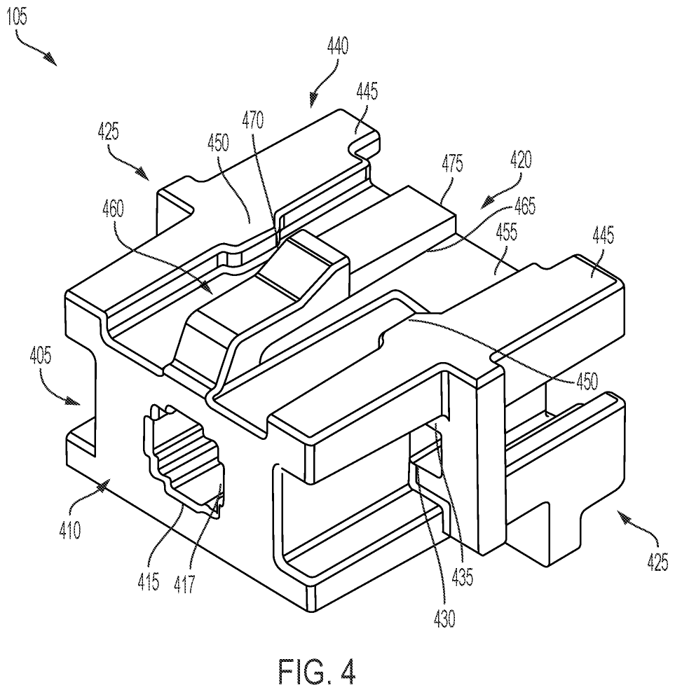

FIG. 4 depicts a perspective view of the housing 105. The housing 105 can include at least one body 405. At least a portion of the body 405 can be inserted into an opening or a receiving pocket of a battery subassembly (e.g., a battery module). For example, at least a portion of the body 405 can be disposed in the battery subassembly. The body 405 can provide a support structure to position the sensing element 110 at a desired location or position relative to the battery subassembly, or a component of the battery subassembly (e.g., a battery cell).

The housing 105 can have a plurality of sides. The sides can be planar or non-planar. For example, a planar side can be flat, straight, or in a single plane. A non-planar side can be in various planes. For example, a non-planar side can have a raised section, a recessed section, a contoured section, an angled section, or any combination thereof. The housing 105 can have a front side 410. The front side 410 can be planar, for example. The front side 410 of the housing 105 can include or define at least one front opening 415. At least a portion of the sensing element 110 can be disposed in the front opening 415. For example, the head 305 can be disposed in the front opening 415. The front side 410 can be disposed in a battery subassembly.

The front opening 415 can have any shape. For example, the shape of the front opening 415 can be based, at least partially, on a shape of the head 305 of the sensing element 110. For example, the shape of the front opening 415 can be the same as the shape of the head 305, as shown in FIG. 2, among others. The shape of the front opening 415 can be different than the shape of the head 305. For example, the front opening 415 can have a shape that defines or provides at least one gap 417 between the head 305 and the body 405 of the housing 105. For example, only a portion of the head 305 can interface with the perimeter of the front opening 415 of the body 405. As shown in FIG. 3, among others, the head 305 can have a square cross-sectional shape. As shown in FIG. 4, among others, the front opening 415 can have a shape such that only a portion of the square head 305 (e.g., the corners) can contact or interface with the body 405 and at least one gap 417 is defined between other portions (e.g., the sides) of the head 305 and the body 405. The head 305 and the front opening 415 can have any shape such that the front opening 415 can have any number of contact points with the head 305 and any number of gaps 417 between the body 405 and the head 305. The gap 417 can isolate the sensing element 110 from the housing 105. For example, the gap 417 can limit or reduce the heat transfer between the sensing element 110 and the housing 105.

The housing 105 can have a rear side 420. The rear side 420 can be opposite the front side 410. The rear side 420 can be non-planar, for example. The housing 105 can have at least one housing side 425. The housing side 425 can extend between the front side 410 and the rear side 420. The housing 105 can have a plurality of housing sides 425. For example, the body 405 can have a left housing side 425 and a right housing side 425. The right and left housing side 425 can be symmetrical or not symmetrical.

The housing side 425 can include a slot 430. The slot 430 can receive a portion of the locking component 115 to couple the locking component 115 with the housing 105. The housing side 425 can include a coupling feature, shown as wall 435. The wall 435 can interface with a component of the locking component 115 to prevent the locking component from detaching from the housing 105.

The housing 105 can have a top side 440. The top side 440 can be non-planar. For example, the top side 440 can include at least one raised section, shown as edge projection 445. The edge projection 445 can extend along the top side 440 between the front side 410 and the rear side 420. The edge projection 445 can be disposed at an outer edge of the top side 440. For example, the edge projection 445 can be disposed on a right or left side of the top side 440 (e.g., can extend along a top right or top left edge of the housing 105). The top side 440 can have a plurality of edge projections 445. For example, a first edge projection 445 can extend along an outer right side of the top side 440. A second edge projection 445 can extend along an outer left side of the top side 440. The top side 440 of the housing 105 can include a housing surface 455. The housing surface 455 can extend between the first edge projection 445 and the second edge projection 445.

The edge projections 445 can include at least one side protrusion 450. The side protrusion 450 can engage with the locking component 115 to maintain a position of the locking component 115 relative to the housing 105. The side protrusion 450 can extend inward from the edge projection 445. For example, the side protrusion 450 can extend toward an opposite side of the housing 105. A first edge projection 445 can have a first side protrusion 450. A second edge projection 445 can have a second side protrusion 450. The first side protrusion 450 can extend toward the second edge projection 445. The second side protrusion 450 can extend toward the first edge projection 445.

The housing 105 can include at least one tab 460. The tab 460 can extend from the body 405. For example, the tab 460 can extend from the top side 440 (e.g., the housing surface 455). The tab 460 can be disposed centrally on the top side 440. The tab 460 can be disposed between the first and second edge projections 445. The tab 460 can be an elongated member. The tab 460 can extend along the housing surface 455. For example, the tab 460 can extend from a location proximate to a front edge of the top side 440 (e.g., proximate the front side 410 of the housing 105). The tab 460 can extend along the housing surface 455 such that a distal end of the tab 460 is disposed proximate the rear side 420 of the body 405. At least a portion of the tab 460 can be disposed away from the housing surface 455. For example, the tab 460 can have a tab surface 465. The tab surface 465 can be disposed opposite the housing surface 455. For example, the tab surface 465 can be facing the housing surface 455. The tab surface 465 can be disposed away from the housing surface 455.

The tab 460 can include at least one housing engagement element 470. The housing engagement element 470 can interface with a housing retaining element of an external component (e.g., a battery subassembly, a battery module) to couple the housing 105 with the external component. The housing engagement element 470 can extend from the tab 460 in a direction away from the housing surface 455. The tab 460 can include at least one stopper surface 475. The stopper surface 40 can be disposed at the distal end of the tab 460. The stopper surface 475 can prevent unwanted or premature engagement between the housing 105 and the locking component 115.

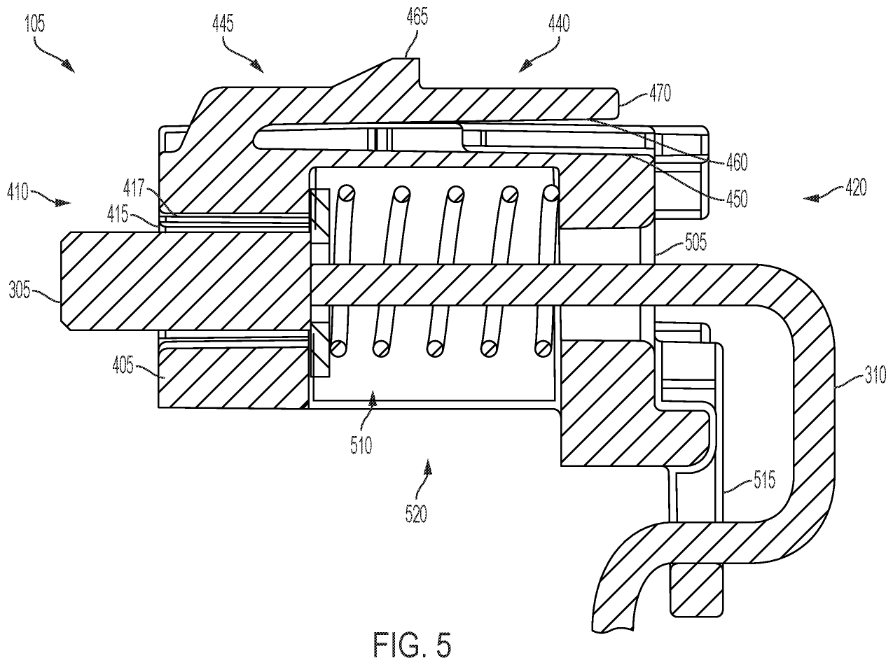

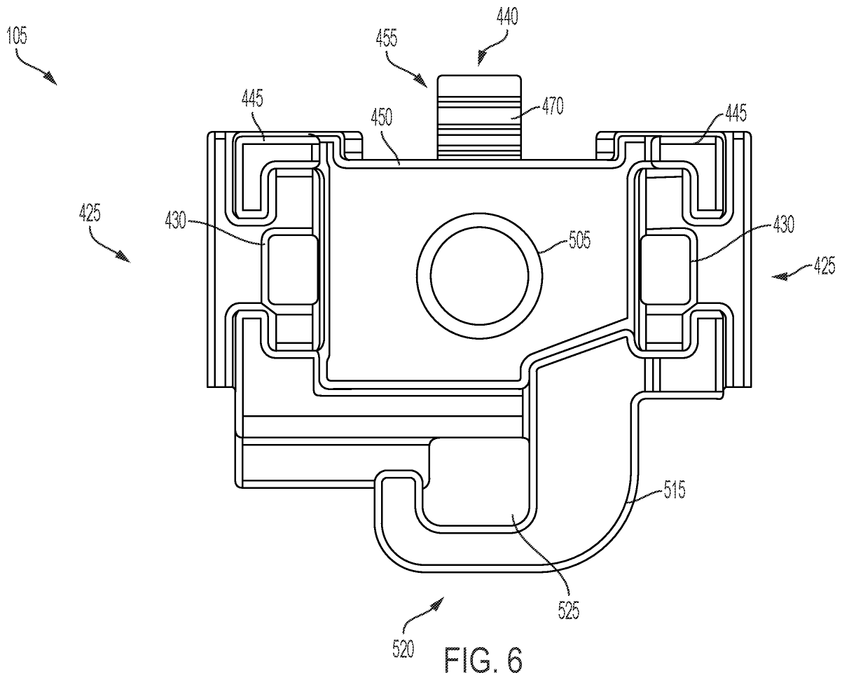

FIG. 5 depicts a side cross-sectional view of the housing assembly 100 without the locking component 115. FIG. 6 depicts a rear view of the housing 105. The rear side 420 of the housing 105 can include or define at least one rear opening 505. The rear opening 505 can align with the front opening 415. At least a portion of the conduit 310 can extend through the rear opening 505. The body 405 of the housing 105 can define a cavity 510. The cavity 510 can extend between the front opening 415 and the rear opening 505. A portion of the sensing element 110 can be disposed in the cavity 510. For example, the head 305 can be disposed in the front opening 415. The head 305 can extend through the front opening 415 such that a front portion of the head 305 can be disposed external to the housing 105. A rear portion of the head 305 can be disposed in the cavity 510. At least a portion of the conduit 310 can be external to the head 305. The conduit 310 can extend from the head 305, through the cavity 510, and through the rear opening 505 such that a portion of the conduit 310 can be external to the housing 105.

The housing 105 can include a support structure 515. The support structure 515 can support the portion of the conduit 310 that is disposed external to the housing 105. The support structure 515 can be disposed on the rear side 420 of the housing 105. The housing 105 can have a bottom side 520. The support structure 515 can extend beyond the bottom side 520 of the housing 105. The support structure 515 can have a hook-like structure. For example, the support structure 515 can define a pocket 525. The conduit 310 can be disposed in the pocket 525.

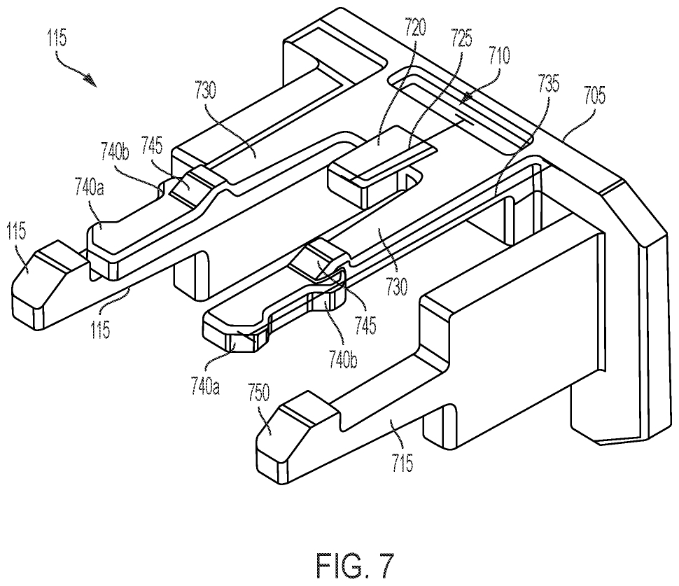

FIG. 7 depicts a perspective view of the locking component 115. The locking component 115 can include at least one plate 705. The plate 705 can interface or engage with the rear side 420 of the housing 105. The plate 705 can interface with the member 205 to cause the sensing element 110 to remain in contact with the target object (e.g., battery cell). The plate 705 can apply enough force to the target object via the member 205 to keep the sensing element 110 in a desired position. The member 205 can provide enough tolerance such that the sensing element 110 remains in contact with the target object despite slight variations in spacing, location, or geometry.

The locking component 115 can include at least one projection 710. The projection 710 can extend from the plate 705. The projection 710 can extend along a top side 440 of the housing 105. The projection 710 can interface or engage with the top side 440 of the housing 105, or a component thereof (e.g., the tab 460). The locking component 115 can include at least one side arm 715. The side arm 715 can extend from the plate 705. The side arm 715 can extend along a housing side 425 of the housing 105. The side arm 715 can interface or engage with the housing side 425, or a component thereof (e.g., the wall 435).

The projection 710 can include at least one stopper body 720. The stopper body 720 can prevent unwanted or premature engagement between the locking component 115 and the housing 105. For example, the stopper body 720 can be positioned to interface with the stopper surface 475 of the tab 460 to prevent other components of the locking component from engaging with the housing 105. The stopper body 720 can extend a first distance, shown as stopper distance 725, from the plate 705.

The projection 710 can include at least one projection arm 730. The projection arm 730 can couple or engage the locking component 115 with the housing 105. The projection arm 730 can extend alongside the stopper body 720. The projection arm 730 can be spaced away from the stopper body 720. The projection 710 can include a plurality of projection arms 730. For example, the projection 710 can include a first projection arm 730 and a second projection arm 730. The first projection arm 730 can be on a first side of the stopper body 720 and the second projection arm 730 can be on a second (e.g., opposite) side of the stopper body 720. The projection arm 730 can extend a second distance, shown as projection arm distance 735, from the plate 705. The projection arm distance 735 can be greater than the stopper distance 725.

The projection arm 730 can include at least one arm protrusion 740. The arm protrusion 740 can engage with the housing 105 to maintain a position of the locking component 115 relative to the housing 105. For example, the arm protrusion 740 can interface with or engage the side protrusion 450 of the housing 105. The arm protrusion 740 can extend outward from a side of the projection arm 730. For example, the arm protrusion 740 can extend in a direction away from the stopper body 720. The projection arm 730 can include a plurality of arm protrusions 740. For example, the projection arm 730 can have a first arm protrusion 740a and a second arm protrusion 740b. The first arm protrusion 740a can be disposed at or proximate to a distal end of the projection arm 730 disposed away from the plate 705. The second arm protrusion 740b can be disposed between the first arm protrusion 740a and the plate 705. The second arm protrusion 740b can be disposed closer to the first arm protrusion 740a than the plate 705.

The arm protrusion 740 can facilitate coupling the locking component 115 with the housing 105. For example, the arm protrusion 740 can be disposed on a first side of the side protrusion 450 and the plate 705 can be disposed on a second (e.g., opposite side) of the side protrusion 450. The arm protrusion 740 can engage with the side protrusion 450 of the housing 105 to couple the locking component 115 with the housing 105 (e.g., to prevent the locking component 115 from decoupling from the housing 105). The first arm protrusion 740a and the second arm protrusion 740b can facilitate in the coupling, based on a position of the locking component 115.

The projection arm 730 can include at least one arm engagement element 745. The arm engagement element 745 can interface with an external component (e.g., a battery subassembly) to move the projection 710 between a first position and a second position. For example, the first position can be a natural position of the projection arm 730 (e.g., a position of the projection arm 730 with no forces applied). The second position can be an unnatural or forced position of the projection arm 730. The projection 710 can move between the first position and the second position based on the external component contacting the arm engagement element 745. A portion of the projection 710 can interface with the stopper surface 475 of the tab 460 of the housing 105 with the projection 710 in the first position. For example, the stopper body 720 can interface with the stopper surface 475. The first position can prevent unwanted engagement between the housing 105 and the locking component 115 (e.g., before the housing 105 is coupled with or disposed partially in a battery subassembly). A portion of the projection 710 can be disposed between the housing surface 455 and the tab 460 with the projection 710 in the second position. For example, the stopper body 720 can be disposed between the housing surface 455 and the tab surface 465. The second position can facilitate engagement between the housing 105 and the locking component 115.

The side arm 715 can couple the locking component 115 with the housing 105. For example, the side arm 715 can loosely couple the locking component 115 with the housing 105 (e.g., the locking component 115 and the housing 105 can move relative to each other, but are still connected). The locking component 115 can be removably coupled with the housing 105.

The side arm 715 can include at least one side arm protrusion 750. The side arm protrusion 750 can extend from a top surface of the side arm 715. The side arm protrusion 750 can be disposed at a distal end of the side arm 715 (e.g., disposed away from the plate 705). The side arm protrusion 750 can interface with the wall 435 of the housing 105 to maintain the coupling between the housing 105 and the locking component 115. For example, to couple the locking component 115 with the housing 105, the side arm 715 can slide along a housing side 425 of the housing 105 in a first direction until the side arm protrusion 750 slides through the slot 430 of the housing 105. With the side arm protrusion 750 through the slot 430, with locking component is loosely coupled with the housing 105 such that the locking component 115 can still move relative to the housing 105. If the locking component 115 were to move in a second direction opposite the first direction, the side arm protrusion 750 can interface with the wall 435 to prevent the side arm 715 and the side arm protrusion 750 from sliding back through the slot 430.

The locking component 115 can have a plurality of side arms 715. For example, the locking component can have a first side arm 715 and a second side arm 715. The first side arm 715 can be disposed on a first side of the projection 710. The second side arm 715 can be disposed on a second (e.g., opposite) side of the projection 710. The first side arm 715 can extend along a first housing side 425 of the housing 105 and through a first slot 430 of the housing 105. The second side arm 715 can extend along a second (e.g., opposite) housing side 425 of the housing 105 and through a second slot 430 of the housing 105.

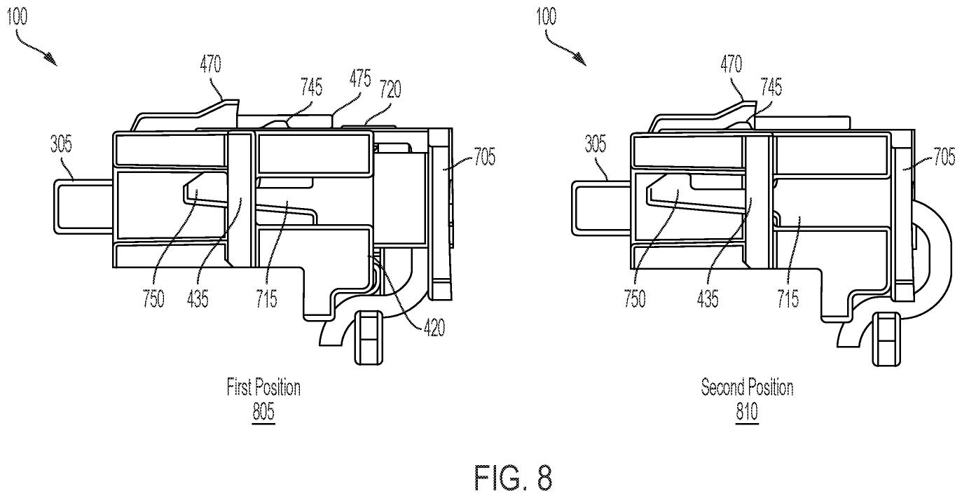

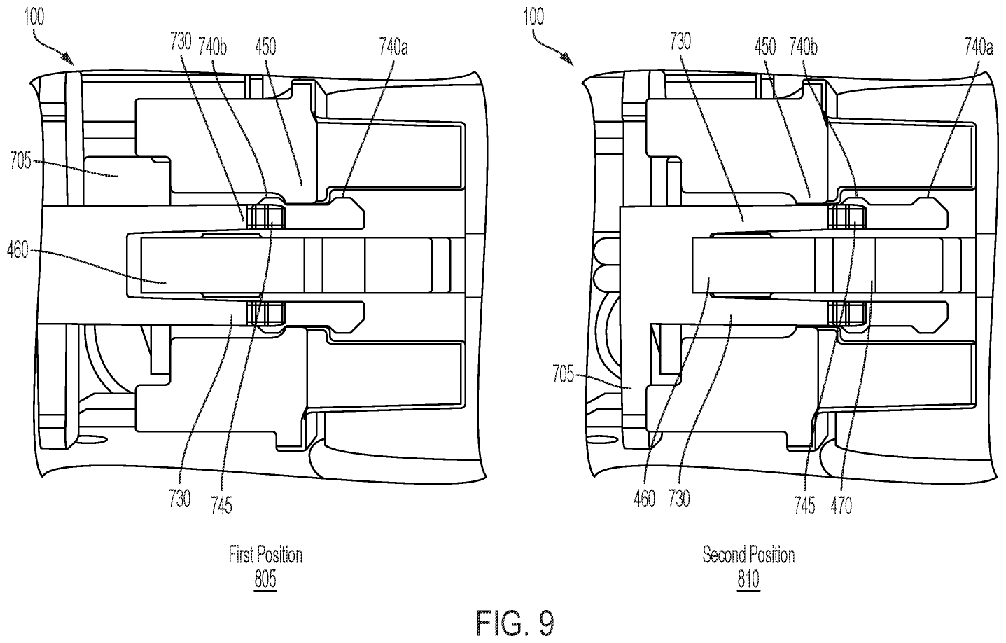

FIG. 8 depicts side views of the housing assembly 100 with the locking component 115 in a first position 805 and a second position 810. FIG. 9 depicts top views of the housing assembly 100 with the locking component 115 in the first position 805 and the second position 810. The first position 805 can be a coupled position (e.g., loosely coupled position). The second position 810 can be a locking position. The locking component 115 can move between a first position 805 and a second position 810 relative to the housing 105. The locking component 115 can move between the first position 805 and the second position 810 while coupled with the housing 105. For example, the locking component 115 can be coupled with the housing 105 with the side arm 715 extending through the slot 430 of the housing 105 such that the side arm protrusion 750 is disposed on a first side of the wall 435 and the plate 705 is disposed on a second (e.g., opposite) side of the wall 435. In the first position, the side arm protrusion 750 can interface with the wall 435. In the first position 805, the plate 705 can be disposed away from the rear side 420 of the housing 105. In the first position 805, the stopper body 720 can interface with the stopper surface 475 of the tab 460. In the first position 805, the projection 710 can be in a first projection position. In the first position 805, the side protrusion 450 can be disposed between a first arm protrusion 740a and a second arm protrusion 740b.

The projection 710 can move from the first projection position to a second projection position to facilitate movement of the locking component 115 from the first position 805 to the second position 810. For example, in the first projection position, the stopper body 720 can at least partially align (e.g., vertically) with the tab 460 such that the stopper body 720 can interface with the stopper surface 475. The interaction between the stopper body 720 and the stopper surface 475 can prevent the locking component 115 from moving from the first position 805 to the second position 810. In the second projection position, the stopper body 720 can be offset (e.g., vertically) from the tab 460 such that the stopper body 720 can be disposed between the tab 460 and the body 405 of the housing 105. For example, the stopper body 720 can be disposed between the housing surface 455 and the tab surface 465.

The projection 710 can move from the first projection position to the second projection position based on a force applied to the arm engagement element 745. For example, a force can push the projection 710 closer to the housing surface 455 such that the stopper body 720 can slide between the tab 460 and the body 405 of the housing 105. The housing 105 can be at least partially disposed in an external component such that the external component can apply the force to the arm engagement element 745. For example, the housing 105 can be disposed in a battery subassembly. The battery subassembly can apply the force to the arm engagement element 745 such that the locking component 115 can move from the first position 805 to the second position 810.

In the second position 810, the side arm protrusion 750 can be space away from the wall 435. In the second position 810, the plate 705 can interface with the rear side 420 of the housing 105. In the second position 810, the stopper body 720 can be disposed between the tab surface 465 and the housing surface 455. In the second position 810, the projection 710 can be in the second projection position. In the second position 810, the side protrusion 450 can be between the second arm protrusion 740b and the plate 705. The second arm protrusion 740b can maintain the locking component 115 in the second position 810 by engaging the side protrusion 450 (e.g., prevent the locking component 115 from moving back to the first position 805).

The locking component 115 can move from the second position 810 to the first position 805. For example, the plate 705 can receive a force (e.g., be pinched or squeezed) such that the second arm protrusion 740b can disengage from the side protrusion 450 and slide around the side protrusion 450. The locking component 115 can be decoupled from the housing 105 by adjusting an orientation of the locking component 115 such that the side arm protrusion 750 can slide back through the slot 430.

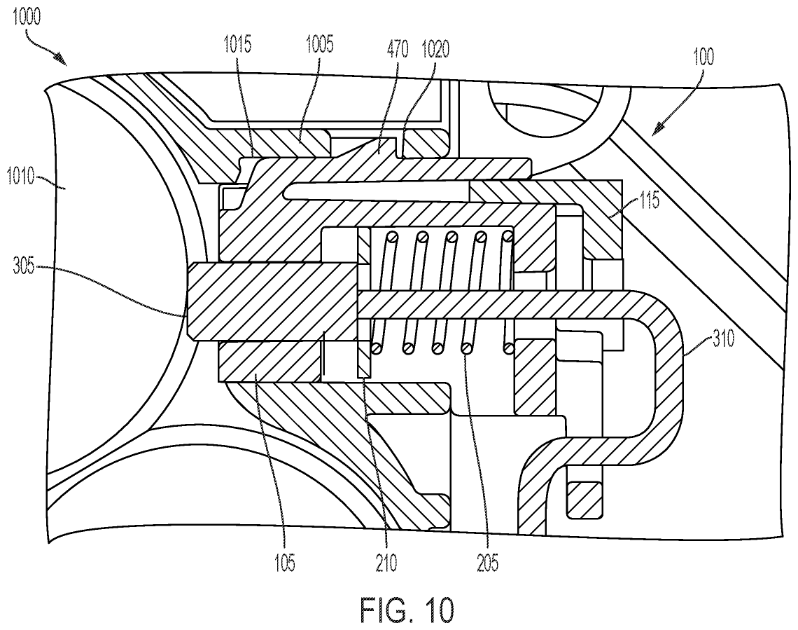

FIG. 10 depicts a top view of a portion of a battery subassembly 1000, with the housing assembly 100 coupled with the battery subassembly 1000. The battery subassembly 1000 can include at least one housing, shown as cell carrier 1005. The battery subassembly 1000 can include at least one energy storage device, shown as battery cell 1010. The battery cell 1010 can be disposed in the cell carrier 1005. The battery subassembly 1000 can include a plurality of battery cells 1010. The housing assembly 100 can facilitate proper positioning of a sensing element 110 such that the sensing element 110 can detect a temperature of a battery cell 1010. For example, the cell carrier 1005 can include at least one housing receptacle 1015. The housing receptacle 1015 can extend through a wall of the cell carrier 1005 to provide access for the housing assembly 100 to contact the battery cell 1010. At least a portion of the housing assembly 100 can be disposed in the housing receptacle 1015 of the cell carrier 1005. The cell carrier 1005 can include any number of housing receptacles 1015 to accommodate any number of housing assemblies 100. The housing assembly 100 can facilitate constant contact between the sensing element 110 and the battery cell 1010.

The housing assembly 100 can couple with the cell carrier 1005 of the battery subassembly 1000. For example, the housing 105 can couple with the cell carrier 1005 battery subassembly. The battery subassembly 1000 can include at least one retaining element 1020. The retaining element 1020 can be disposed in or be a part of the cell carrier 1005. For example, the retaining element 1020 can be a part of the housing receptacle 1015. The retaining element 1020 can engage the housing engagement element 470 of the housing 105 to couple the housing 105 with the battery subassembly 1000. A portion of the housing 105 can be disposed in the housing receptacle 1015 of the cell carrier 1005 battery subassembly such that the housing engagement element 470 can engage with the retaining element 1020. A plurality of housing assemblies 100 can couple with a battery subassembly 1000. For example, a first housing assembly 100 can couple with the battery subassembly 1000 to cause a first sensing element 110 to contact a first battery cell 1010 to detect a temperature of the first battery cell 1010. A second housing assembly 100 can couple with the battery subassembly 1000 to cause a second sensing element 110 to contact a second battery cell 1010 to detect a temperature of the second battery cell 1010.

The housing 105 can prevent the locking component 115 from moving to the second position 810 until the housing 105 is couple with the battery subassembly 1000. For example, a portion of the cell carrier 1005 can contact the arm engagement element 745 to move the projection 710 between the first projection position and the second projection position. The locking component 115 can move to the second position 810 with the projection 710 in the second projection position.

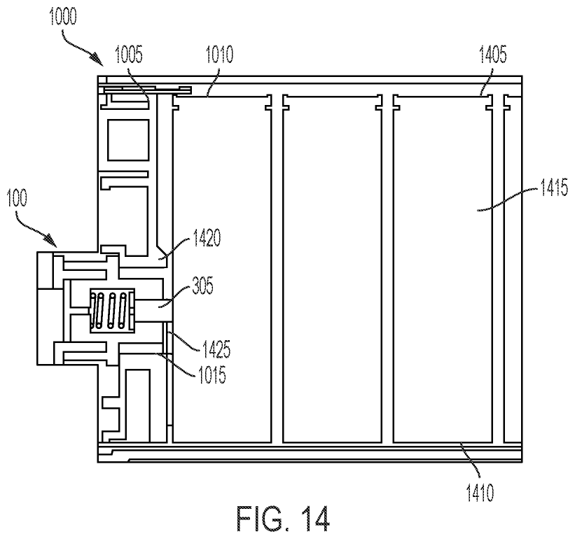

FIG. 14 depicts a side cross-sectional view of the battery subassembly 1000. The battery subassembly 1000 can include a plurality of battery cells 1010 disposed in the cell carrier 1005. The battery cell 1010 can have a first end, shown as top end 1405, and a second end, shown as bottom end 1410. The battery cell 1010 can have a battery sidewall 1415. The battery sidewall 1415 can extend between the top end 1405 and the bottom end 1410.

The sensing element 110 can interface with the battery sidewall 1415 to sense a temperature of the battery cell 1010. For example, the head 305 of the sensing element 110 can contact the battery sidewall 1415 to sense the temperature of the battery cell 1010. The sensing element 110 can contact the battery cell 1010 at any location along the battery sidewall 1415. For example, the sensing element 110 can contact the battery sidewall 1415 at a location closer to the bottom end 1410 than the top end 1405. The sensing element 110 can contact the battery sidewall 1415 at a location closer to the top end 1405 than the bottom end 1410. The sensing element 110 can contact the battery sidewall 1415 at a location proximate to a center between the top end 1405 and the bottom end 1410. The housing receptacle 1015 can be disposed at any location of the cell carrier 1005 to provide the desired positioning of the housing assembly 100 relative to the battery cell 1010.

At least one of the battery subassembly 1000 or the housing assembly 100 can include at least one shielding feature to prevent material (e.g., potting materials, adhesives, etc.) from getting between the sensing element 110 and the battery cell 1010. For example, the cell carrier 1005 can include a first shielding feature, shown as blocker 1420. The blocker 1420 can be disposed at or adjacent to an edge (e.g., a top edge) of the housing receptacle 1015. The blocker 1420 can prevent material from entering the housing receptacle 1015. The blocker 1420 can prevent material from being disposed between the sensing element 110 and the battery cell 1010. For example, the blocker 1420 can extend into the cell carrier 1005 toward the battery cell 1010 to block material from flowing to a position between the sensing element 110 and the battery cell 1010. The blocker 1420 can extend to contact the battery sidewall 1415 to create a barrier such that material cannot reach the sensing element 110. The blocker 1420 can extend around all, or a subset of the sides of the housing receptacle 1015. For example, the blocker 1420 can extend along the top side of the housing receptacle 1015.

The cell carrier 1005 can include a second shielding feature, shown as lip 1425. The lip 1425 can be disposed at or adjacent to an edge (e.g., bottom edge) of the housing receptacle 1015. The lip 1425 can prevent material from entering the housing receptacle 1015. The lip 1425 can extend from the cell carrier 1005 into the housing receptacle 1015. The lip 1425 can extend around all, or a subset of the sides of the housing receptacle 1015. For example, the lip 1425 can extend along the bottom side of the housing receptacle 1015.

The housing assembly 100 can include a shielding feature. For example, the housing 105 can include a shielding feature that extends from the body 405 (e.g., the front side 410). The sensing element 110 can include a shielding feature that extends from the head 305. For example, the housing 105 or the sensing element 110 can include at least one of the blocker 1420 or the lip 1425.

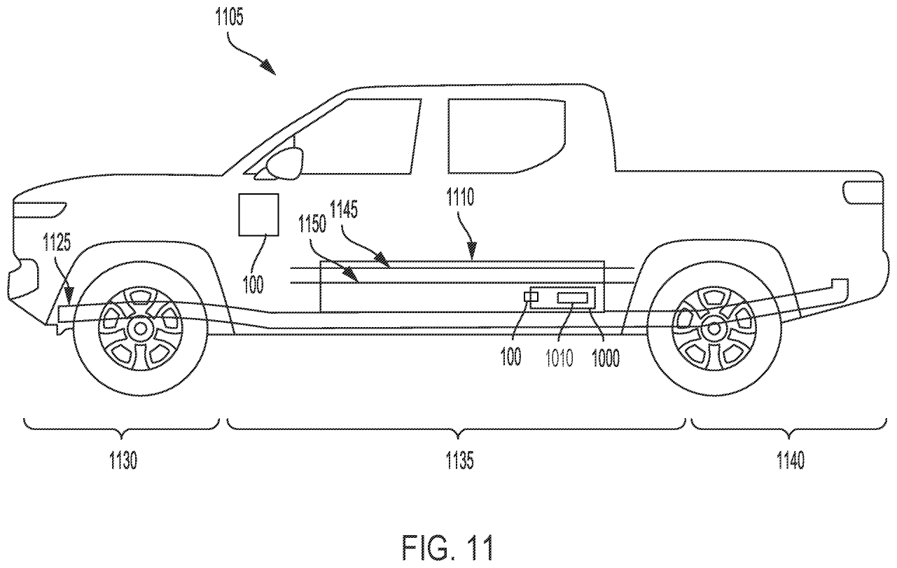

FIG. 11 depicts is an example cross-sectional view of an electric vehicle 1105 installed with at least one battery pack 1110. Electric vehicles 1105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Yet, it should also be noted that battery pack 1110 may also be used as an energy storage system to power a building, such as a residential home or commercial building. Electric vehicles 1105 can be fully electric or partially electric (e.g., plug-in hybrid) and further, electric vehicles 1105 can be fully autonomous, partially autonomous, or unmanned. Electric vehicles 1105 can also be human operated or non-autonomous. Electric vehicles 1105 such as electric trucks or automobiles can include on-board battery packs 1110, battery subassemblies 1000, or battery cells 1010 to power the electric vehicles. The electric vehicle 1105 can include a chassis 1125 (e.g., a frame, internal frame, or support structure). The chassis 1125 can support various components of the electric vehicle 1105. The chassis 1125 can span a front portion 1130 (e.g., a hood or bonnet portion), a body portion 1135, and a rear portion 1140 (e.g., a trunk, payload, or boot portion) of the electric vehicle 1105. The battery pack 1110 can be installed or placed within the electric vehicle 1105. For example, the battery pack 1110 can be installed on the chassis 1125 of the electric vehicle 1105 within one or more of the front portion 1130, the body portion 1135, or the rear portion 1140. The battery pack 1110 can include or connect with at least one busbar, e.g., a current collector element. For example, the first busbar 1145 and the second busbar 1150 can include electrically conductive material to connect or otherwise electrically couple the battery subassemblies 1000 or the battery cells 1010 with other electrical components of the electric vehicle 1105 to provide electrical power to various systems or components of the electric vehicle 1105.

The electric vehicle 1105 can include at least one housing assembly 100. The housing assembly 100 can be coupled with a battery subassembly 1000 of the electric vehicle 1105. A plurality of housing assemblies 100 can be coupled with the battery subassembly 1000. The electric vehicle 1105 can include a plurality of battery subassemblies 1000.

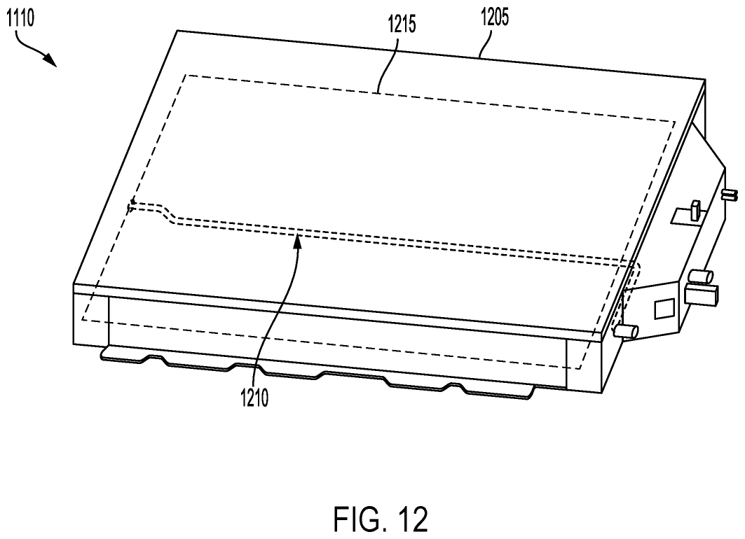

FIG. 12 depicts an example battery pack 1110. Referring to FIG. 12, among others, the battery pack 1110 can provide power to electric vehicle 1105. Battery packs 1110 can include any arrangement or network of electrical, electronic, mechanical or electromechanical devices to power a vehicle of any type, such as the electric vehicle 1105. The battery pack 1110 can include at least one battery pack housing 1205. The battery pack housing 1205 can include at least one battery subassembly 1000 or at least one battery cell 1010, as well as other battery pack components. The battery subassembly 1000 can be or can include one or more groups of prismatic cells, cylindrical cells, pouch cells, or other form factors of battery cells 1010. The battery pack housing 1205 can include a shield on the bottom or underneath the battery subassembly 1000 to protect the battery subassembly 1000 and/or battery cells 1010 from external conditions, for example if the electric vehicle 1105 is driven over rough terrains (e.g., off-road, trenches, rocks, etc.) The battery pack 1110 can include at least one cooling line 1210 that can distribute fluid through the battery pack 1110 as part of a thermal/temperature control or heat exchange system that can also include at least one thermal component (e.g., cold plate) 1215. The thermal component 1215 can be positioned in relation to a top submodule and a bottom submodule, such as in between the top and bottom submodules, among other possibilities. The battery pack 1110 can include any number of thermal components 1215. For example, there can be one or more thermal components 1215 per battery pack 1110, or per battery subassembly 1000. At least one cooling line 1210 can be coupled with, part of, or independent from the thermal component 1215.

The thermal component 1215 can control a temperature of a battery subassembly 1000. For example, the thermal component 1215 can control the temperature of a battery subassembly 1000 based on at least one temperature detected or determined by the sensing element 110 of the housing assembly 100. For example, a first sensing element 110 can determine a first temperature of a first battery cell 1010. A second sensing element 110 can determine a second temperature of a second battery cell 1010. The thermal component 1215 can control a temperature of the battery subassembly 1000 based on the first temperature and the second temperature.

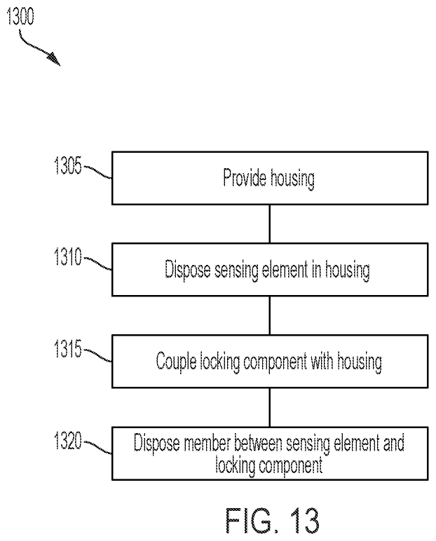

FIG. 13 depicts a flow diagram of an example method 1300 for assembling a housing assembly 100. Method 1300 can include providing a housing 105 (Act 1305). The housing 105 can be structured to couple with an external component (e.g., a battery subassembly) to provide a support structure to position a device or element at a desired position or location relative to the external component. The housing 105 can include a front opening 415 and a rear opening 505. The housing 105 can define a cavity 510. The cavity 510 can extend between the front opening 415 and the rear opening 505.

Method 1300 can include disposing a sensing element 110 in a housing 105 (Act 1310). The sensing element 110 can have a head 305 and a conduit 310 that is disposed at least partially outside of the head 305. The sensing element 110 can be at least partially disposed in the housing 105. For example, the head 305 can be disposed in the front opening 415 of the housing 105. A front portion of the head 305 can be disposed external to the housing 105 and a rear portion of the head 305 can be disposed in the cavity 510. Act 1310 can include extending the conduit 310 from the rear portion of the head 305 through the rear opening 505. Act 1310 can include supporting a portion of the conduit 310 that is disposed external to the housing via a support structure 515 of the housing 105.

Method 1300 can include disposing a member 205 in the housing 105 (Act 1315). The member 205 can be flexible or compliant to accommodate for various tolerances regarding the housing assembly 100 and the target objects. Act 1315 can include disposing the member 205 around the conduit 310 of the sensing element 110. The member 205 can be disposed in the cavity 510. Act 1315 can include disposing a washer 210 in the housing 105. The washer 210 can be disposed between the member 205 and the head 305 of the sensing element 110. The member 205 can contact the washer 210 to apply a force to the sensing element 110 to keep the sensing element 110 in contact with a target object (e.g., a battery cell 1010). The member 205 can be disposed around the conduit 310.

Method 1300 can include coupling a locking component 115 with the housing 105 (Act 1320. The locking component 115 and the member 205 can cause the sensing element 110 to remain in contact with a battery cell 1010. The member 205 can be disposed between the sensing element 110 (e.g., the head 305 of the sensing element 110) and the locking component 115. The housing 105 can have a front side 410 and a rear side 420. The housing can have a top side 440 with a housing surface 455. The housing surface 455 can extend between the front side 410 and the rear side 420. The housing 105 can include a tab 460 that extends from the housing surface 455. The housing 105 can have an edge projection 445 that extends along a top edge of the housing 105 between the front side 410 and the rear side 420 The housing 105 can have a housing side 425. The housing side 425 can have a slot 430 and a wall 435.

The locking component 115 can have a plate 705. The locking component 115 can have a projection 710 and a side arm 715 that extends from the plate 705. The projection 710 can have a stopper body 720 and a projection arm 730. The projection arm 730 can have an arm protrusion 740 and an arm engagement element 745. The side arm 715 can have a side arm protrusion 750.

Coupling the locking component 115 with the housing 105 can include disposing a side arm 715 along a first side (e.g., a housing side 425) of the housing 105 and disposing a projection arm 730 along a second side (e.g., a top side 440) of the housing 105. The side arm 715 can couple the locking component 115 with the housing 105. The projection arm 730 can facilitate movement of the projection 710 between a first projection position and a second projection position to move the locking component 115 to a locking position relative to the housing 105.

Act 1320 can include preventing the locking component 115 from moving to the locking position with the housing 105 disconnected from a battery subassembly 1000. For example, preventing the locking component 115 from moving to the locking position can include interfacing the stopper body 720 with a stopper surface 475 of the tab 460. With the projection 710 in a first projection position, at least a portion of the stopper body 720 can align (e.g., vertically) with the tab 460. The tab 460 can prevent the locking component 115 from moving to the locking position (e.g., the second position 810).

Act 1320 can include locking the locking component 115 with the housing 105. Act 1320 can include moving the projection 710 from a first projection position to a second projection position via a force applied by an external component (e.g., a battery subassembly 1000). The battery subassembly 1000 can interface with the arm engagement element 745 to move the projection 710. With the projection in the second projection position, the locking component 115 can move from the first position 805 to the second, locking position 810. Locking the locking component 115 can include disposing the stopper body 720 between the tab 460 and the housing surface 455. Locking the locking component 115 can include interfacing the plate 705 with the rear side 420 of the housing 105.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single. more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, descriptions of top and bottom, front and back, or left and right may be reversed or interchangeable. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a sensing element disposed at least partially in a housing;
the sensing element held in the housing via a locking component and a member, the locking component and the member to cause the sensing element to remain in contact with a battery cell of a vehicle.

2. The apparatus of claim 1, comprising:
the housing, comprising:
a housing surface; and
a tab, at least a portion of the tab disposed away from the housing surface, the tab comprising a stopper surface;
the locking component, comprising:
a plate; and
a projection extending from the plate;
the projection to move between a first position and a second position, the projection to interface with the stopper surface in the first position to prevent unwanted engagement between the housing and the locking component, the projection to be disposed between the housing surface and the tab in the second position, the plate to interface with the housing with the projection in the second position to cause the sensing element to remain in contact with the battery cell.

3. The apparatus of claim 1, comprising:
the locking component, comprising:
a plate; and
a projection extending from the plate, the projection comprising a stopper body and a projection arm, the projection arm comprising an arm engagement element to interface with a battery subassembly, the battery subassembly comprising the battery cell;
the housing comprising a housing surface and a tab, the tab comprising:
a housing engagement element to interface with a housing retaining element of the battery subassembly;
a tab surface disposed opposite the housing surface; and
a stopper surface disposed at an end of the tab;
the projection to move between a first position and a second position based on the battery subassembly contacting the arm engagement element, the stopper body of the projection to interface with the stopper surface with the projection in the first position, the stopper body to be disposed between the housing surface and the tab surface with the projection in the second position.

4. The apparatus of claim 1, comprising:
the housing comprising a housing side and a top side;
the locking component to move between a first position and a second position relative to the housing, the locking component comprising:
a plate;
a side arm extending from the plate along the housing side, the side arm to couple the locking component with the housing with the locking component in the first position; and
a projection arm extending from the plate along the top side, the projection arm to move from a first arm position to a second arm position to facilitate movement of the locking component from the first position and the second position.

5. The apparatus of claim 1, comprising:
the housing comprising a housing engagement element to couple the housing with a battery subassembly, the battery subassembly comprising the battery cell, a portion of the housing to be disposed in the battery subassembly.

6. The apparatus of claim 1, comprising:
the locking component removably coupled with the housing; and
the locking component to move between a first position and a second position relative to the housing.

7. The apparatus of claim 1, comprising:
the member being a compliant member to provide tolerance to the sensing element to keep the sensing element in contact with the battery cell of the vehicle.

8. The apparatus of claim 1, comprising:
the sensing element comprising a head and a conduit, a portion of the conduit disposed outside the head; and
the housing comprising a first opening, a second opening, and a support structure, the head disposed in the first opening and the portion of the conduit extending through the second opening, the support structure to support the portion of the conduit.

9. The apparatus of claim 1, comprising:
the sensing element comprising a head and a conduit, the head to contact the battery cell; and
a washer disposed between the head and the member, the washer and the member disposed around the conduit, the member extend between the washer and the locking component.

10. The apparatus of claim 1, comprising:
the sensing element comprising a head; and
the housing comprising an opening, the head to extend through the opening, a portion of the head disposed external to the housing to contact the battery cell to detect a temperature of the battery cell.

11. A method, comprising:
providing a housing;
disposing a portion of a sensing element within the housing;
disposing a member in the housing; and
coupling a locking component with the housing, the member disposed between the sensing element and the locking component, the locking component and the member to cause the sensing element to remain in contact with a battery cell.

12. The method of claim 11, wherein the housing comprises a tab, a rear side, and a housing surface and the locking component comprises a plate and a stopper body, the method comprising:
interfacing the stopper body with a stopper surface of the tab with the locking component in a first position;
disposing the stopper body between the tab and the housing surface with the locking component in a second position; and
interfacing the plate with the rear side of the housing with the locking component in the second position.

13. The method of claim 11, comprising:
preventing the locking component from moving to a locking position with the housing disconnected from a battery subassembly.

14. The method of claim 11, comprising:
preventing the locking component from moving from a first position to a second position relative to the housing with a projection of the locking component being in a first projection position;
moving the projection from the first projection position to a second projection position via a battery subassembly, the battery subassembly to interface with an arm engagement element of the projection to move the projection; and
moving the locking component from the first position to the second position with the projection in the second projection position.

15. The method of claim 11, comprising:
disposing a first arm of the locking component along a first side of the housing; and
disposing a second arm of the locking component along a second side of the housing;
the first arm to couple the locking component with the housing; and
the second arm to facilitate movement of the locking component between a first position and a projection.

16. The method of claim 11, comprising:
disposing a head of the sensing element in a first opening of the housing;
extending a portion of a conduit of the sensing element from the head and through a second opening of the housing; and
disposing a washer between the member and the head of the sensing element, the washer and the member disposed around the portion of the conduit.

17. A vehicle, comprising:
a battery subassembly, the battery subassembly comprising a battery cell; and
a housing assembly coupled with the battery subassembly, the housing assembly comprising:
a housing;
a sensing element disposed at least partially in the housing;
a locking component to hold the sensing element within the housing; and
a member disposed between the sensing element and the locking component to cause the sensing element to remain in contact with the battery cell of the vehicle.

18. The vehicle of claim 17, comprising:
the battery subassembly comprising a plurality of battery cells, the plurality of battery cells comprising a first battery cell and a second battery cell, the battery cell being the first battery cell;
a plurality of housing assemblies comprising a first housing assembly and a second housing assembly, the housing assembly being the first housing assembly, the first housing assembly comprising a first sensing element and the second housing assembly comprising a second sensing element, the first sensing element to contact the first battery cell to determine a first temperature of the first battery cell, the second sensing element to contact the second battery cell to determine a second temperature of the first battery cell; and
a thermal component to control a temperature of the battery subassembly based on the first temperature and the second temperature.

19. The vehicle of claim 17, comprising:
the housing assembly, comprising:
the housing, comprising:
a housing surface; and
a tab, at least a portion of the tab disposed away from the housing surface, the tab comprising a stopper surface;
the locking component, comprising:
a plate; and
a projection extending from the plate;
the locking component to move between a first position and a second position, the projection to interface with the stopper surface with the locking component in the first position to prevent unwanted engagement between the housing and the locking component with the housing assembly detached from the battery subassembly, the projection to be disposed between the housing surface and the tab and the plate to interface with a wall with the locking component in the second position to cause the sensing element to remain in contact with the battery cell.

20. The vehicle of claim 17, comprising:
the battery subassembly comprising a retaining element; and
the housing assembly, comprising:
the locking component, comprising:
a plate; and
a projection extending from the plate, the projection comprising a stopper body and a projection arm, the projection arm comprising an arm engagement element to interface with the battery subassembly;
the housing comprising a housing surface and a tab, the tab comprising:
an engagement element to interface with the retaining element;
a tab surface disposed opposite the housing surface; and
a stopper surface disposed at an end of the tab;
the battery subassembly to move the projection between a first position and a second position via the arm engagement element, the stopper body to interface with the stopper surface with the projection in the first position, the stopper body to be disposed between the housing surface and the tab surface with the projection in the second position.
